(19) United States
(12) Patent Application Publication
(10) Pub. No.: US 2013/0105161 A1
(43) Pub. Date: May 2, 2013

(54) Delayed, Swellable Particles for Prevention of Fluid Migration Through Damaged Cement Sheaths

(71) Applicants: Gary P. Funkhouser, Duncan, OK (US); James R. Benkley, Duncan, OK (US)

(72) Inventors: Gary P. Funkhouser, Duncan, OK (US); James R. Benkley, Duncan, OK (US)

(73) Assignee: Halliburton Energy Services, Inc., Houston, TX (US)

(21) Appl. No.: 13/282,599

(22) Filed: Oct. 27, 2011

(51) Int. Cl. E21B 33/13; C08F 220/56; C08F 220/10; C09K 8/46

(52) U.S. Cl. 166/293; 523/130; 428/402

(57) ABSTRACT

A method includes providing a cementing composition that includes an aqueous fluid, a cementitious particulate, and a copolymer particulate which includes a monofunctional monomer, a water degradable first crosslinker, and a second crosslinker. The method further includes placing the cementing composition in a subterranean formation so as to form a set cement sheath and swelling the copolymer particulate in response to a void created in the set cement sheath. The copolymer particulate allows the cementing composition to set to form the cement sheath before substantial swelling of the copolymer particulate occurs.

### BACKGROUND

The present invention relates to methods of using delayed swelling copolymer particulates that are compatible with use in cement compositions, including cement compositions used in wellbore cementing applications.

A natural resource such as oil or gas residing in a subterranean formation can be recovered by drilling a well into the formation. To do so, a wellbore is typically drilled down to the subterranean formation while circulating a drilling fluid through the wellbore. After the drilling is terminated, a string of pipe, e.g., casing, is run in the wellbore. Primary cementing is then usually performed whereby a cement composition, usually including water, cement, and particulate additives, is pumped down through the string of pipe and into the annulus between the string of pipe and the walls of the wellbore to allow the cementing composition to set into an impermeable cement column and thereby seal the annulus.

Damaged cement sheaths have been implicated in groundwater contamination in areas of active shale gas production. Damage may occur as a result of the drill string operations that physically impact the walls of the wellbore. Additionally, cement disintegration over time may cause the formation of voids, which may also result in the observed contamination. One exemplary means of addressing these issues employs a secondary cementing operation called squeeze cementing whereby a cementing composition is forced under pressure to areas of lost integrity in the annulus to seal off those areas. Other solutions to damaged cement sheaths may involve operations with supplemental treatment fluids containing particulate barriers to plug voids.

These solutions for addressing the integrity of the cement sheath of the wellbore often may introduce increased costs to perform the supplemental operations. Additionally, even detecting whether such supplemental operations should be undertaken requires active testing, resulting in further costs. Moreover, such detection systems may be responsive and/or sufficiently sensitive on a time scale that does not avoid the environmental impact of a damaged cement sheath. Such delays may result in considerable contamination before an operator can address the integrity of the cement sheath with supplemental operations.

### SUMMARY OF THE INVENTION

The present invention relates to methods of using delayed swelling copolymer particulates that are compatible with use in cement compositions, including cement compositions used in wellbore cementing applications.

In one embodiment, the present invention provides a method that comprises providing a cementing composition comprising an aqueous fluid; a cementitious particulate; and a copolymer particulate comprising a monofunctional monomer, a water degradable first crosslinker, and a second crosslinker, the method further including placing the cementing composition in a subterranean formation so as to form a set cement sheath and swelling the copolymer particulate in response to a void created in the set cement sheath, the copolymer particulate allowing the cementing composition to set to form the cement sheath before substantial swelling of the copolymer particulate occurs.

In one embodiment, the present invention provides a cementing composition comprising an aqueous fluid, a cementitious particulate, and a copolymer particulate comprising a monofunctional monomer, a water degradable first crosslinker, and a second crosslinker, the copolymer particulate allowing the cementing composition to set before substantial swelling of the copolymer particulate occurs.

In one embodiment, the present invention provides a copolymer particulate comprising a monofunctional monomer selected from the group consisting of 1) a mixture of 2-acrylamido-2-methylpropane sulfonic acid (AMPS) or salt thereof and N,N-dimethylacrylamide and 2) an acrylate salt; the reaction further including a diacrylate ester first crosslinking agent and a second crosslinking agent. The copolymer particulate comprises particulates that have a particulate size in a range from about 100 microns to about 2000 microns.

The features and advantages of the present invention will be readily apparent to those skilled in the art upon a reading of the description of the preferred embodiments that follows.

### DETAILED DESCRIPTION

The present invention relates to methods of using delayed swelling copolymer particulates that are compatible with use in cement compositions, including cement compositions used in wellbore cementing applications.

Of the many advantages, the present invention provides methods that utilize a cementing composition comprising a delayed swelling copolymer particulate that does not adversely affect its setting time or the final strength of the set cement sheath, while providing real-time response to damage to the set cement sheath. Without being bound by theory, such damage control may occur by swelling of the copolymer particulate in the set cement sheath in response to physical damage to and/or voids created by natural degradative processes when the copolymer particulate contacts a fluid comprising water. The timescale of the delay in swelling of the copolymer particulate is sufficient to allow the cement sheath to set without appreciable swelling, while being responsive on a timescale that is relevant to providing passive damage control to reduce contamination of the surrounding formation, including averting or substantially reducing ground water contamination. By way of example, a typical wellbore cement sheath may set on a time scale of about eight to about twelve hours. In that time, the copolymer particulate may swell less than about 1% to less than about 10% of its capacity, in some embodiments. In some embodiments, no appreciable swelling occurs during the eight to twelve hour period for the cement to set. Swelling rates can be tailored based on any combination of particulate size and copolymer composition varying labile and stable crosslinkers.

Furthermore, methods of the invention employ cementing compositions with copolymer particulates having tunable swelling properties by adjusting the ratio of stable and labile crosslinkers, thus allowing tailoring of the swelling response time of the copolymer particulate in the cementing composition to accommodate conditions within the wellbore and surrounding formation. Given the guidance provided herein, other advantages will be apparent to the skilled artisan.

In some embodiments, the present invention is directed to a method comprising providing a cementing composition comprising an aqueous fluid, a cementitious particulate, and a copolymer particulate comprising a monofunctional monomer, a water degradable first crosslinker, and a second crosslinker; the method comprising placing this cementing composition in a subterranean formation so as to form a set cement sheath. The swelling of the copolymer particulate occurs in response to a void created in the set cement sheath, while the copolymer particulate allows the cementing composition to set to form the cement sheath before substantial swelling of the copolymer particulate occurs.

As used herein, a “cementing composition,” when used in reference to a cement sheath of a wellbore, refers to any cement formulation that may be used to create a set cement sheath. A “cementing composition,” in other contexts, can encompass any cement formulation that employs dry or wet mixing, such as shotcrete, which includes, for example, gunnite used in pool construction. Cementing compositions utilized in the present invention comprise a “cementitious particulate” which can be any type of particulate included in a hydraulic cement used in forming a wellbore cement sheath, while in other contexts, a cementing composition can comprise a “cementitious particulate” of a non-hydraulic cement. The terms “cement” and “hydraulic cement” may be used interchangeably in this application in the context of a wellbore cement sheath. In some such embodiments, “cement” and “hydraulic cement” refer to compounds of a cementitious nature that set and/or harden in the presence of water. Suitable hydraulic cements for use in the present invention can include any known hydraulic cement including, but are not limited to, a Portland cement including API classes A, B, C, G, and H; a slag cement; a pozzolana cement; a gypsum cement; an aluminous cement; a silica cement; a high alkalinity cement; and any combination thereof. In some embodiments, a cementing composition may comprise an aqueous liquid, a hydraulic cement, and copolymer particulate.

As used herein a “copolymer particulate” refers to the delayed swelling copolymer of the invention, which can respond to the presence of water by swelling via any combination of water absorption and/or partial degradation in the presence of water. In some embodiments, a copolymer particulate of the present invention may comprise a crosslinked particulate, wherein the crosslinked particulate has been formed by a reaction comprising a monofunctional monomer, a water degradable first crosslinker, and a second crosslinker. In some embodiments, a copolymer particulate that is a crosslinked particulate may also be formed from a reaction that comprises a first monofunctional monomer and a second monofunctional monomer, a water degradable first crosslinker, and a second crosslinker In some embodiments, a first monofunctional monomer and a second monofunctional monomer may be different. It should be understood that the term “particulate” or “particle,” as used in this disclosure, includes all known shapes of materials, including, but not limited to, spherical materials, substantially spherical materials, low to high aspect ratio materials, fibrous materials, polygonal materials (such as cubic materials), and mixtures thereof.

A “water degradable first crosslinker” refers to a crosslinker that confers susceptibility of the copolymer particulate structure when exposed to water. “Degradable” is intended to mean that at least some covalent bonds within the crosslinked polymer are compromised, allowing relaxation of the polymer network into a more open structure. This relaxation of the polymer network may be accompanied by a swelling of the copolymer particulate, which may, in turn, also be accompanied by a greater capacity to absorb water. In some embodiments, a water degradable first crosslinker can be replaced with a degradable first crosslinker that degrades via some other mechanism, such as in response to elevated temperatures. In some embodiments, a degradable first crosslinker can degrade by multiple mechanisms, including water degradation, thermal degradation, pH responsive degradation, and any combination thereof.

In some embodiments, the second crosslinker is a stable crosslinker. By “stable” it is meant that the second crosslinker is more robust than the water degradable first crosslinker. It is not intended to imply that the second crosslinker is entirely immune to possible degradation. The second crosslinker is present, at least in part, to limit the ultimate degree of swelling of the copolymer particulate and to prevent the copolymer from dissolving after the first crosslinker is degraded. Thus, by altering the ratio of the water degradable first crosslinker and the second crosslinker, the copolymer swelling response in the presence of water can be controlled.

In some embodiments, the methods of the present invention include placing a cementing composition comprising the copolymer particulate in a subterranean formation so as to form a set cement sheath. Wellbore cementing operations are well known in the art. A cementing operation can be accomplished, for example, by pumping cement into in an otherwise open wellbore. Cementing operations need not include only operations to establish a wellbore casing, but also operations to seal a lost circulation zone, operations to set a plug in an existing well from which to push off with directional tools, and operations to plug a well when it is to be abandoned. Cementing operations in a wellbore involve calculating physical properties of both the slurry and the set cement needed for the particular cementing application, including density and viscosity. To create a set cement sheath, a cementing composition can be pumped into the open wellbore. This may be accomplished concomitantly with the displacement of drilling fluids thus providing the placement of the cement in the wellbore.

In some embodiments, methods of the invention include the swelling of the copolymer particulate in response to a void created in the set cement sheath, while the copolymer particulate still allows the cementing composition to set to form the cement sheath before substantial swelling of the copolymer particulate occurs. In some embodiments, a cementing composition employed in methods of the invention can have a setting time in a range from about eight hours to about twelve hours. In that time frame, the copolymer particulate may exhibit some swelling, but the full swelling capacity of the copolymer particulate is not realized by the time the cement sheath is set. In some embodiments, less than about 20% of the swelling capacity of the copolymer particulate has occurred by the time the cement sheath is set. In some embodiments, less than about 10% of the swelling capacity of the copolymer particulate has occurred by the time the cement sheath is set. In some embodiments, less than about 10% of the swelling capacity of the copolymer particulate has occurred by the time the cement sheath is set. In some embodiments, less than about 5% of the swelling capacity of the copolymer particulate has occurred by the time the cement sheath is set. In some embodiments, less than about 4% of the swelling capacity of the copolymer particulate has occurred by the time the cement sheath is set. In some embodiments, less than about 3% of the swelling capacity of the copolymer particulate has occurred by the time the cement sheath is set. In some embodiments, less than about 2% of the swelling capacity of the copolymer particulate has occurred by the time the cement sheath is set. In some embodiments, less than about 1% of the swelling capacity of the copolymer particulate has occurred by the time the cement sheath is set. In some embodiments, less than about 0.9%, 0.8%, 0.7%, 0.6%, 0.5%, 0.4%, 0.3%, 0.2%, or about 0.1% of the swelling capacity of the copolymer particulate has occurred by the time the cement sheath is set.

One skilled in the art will recognize that alteration of ratios of the labile water degradable first crosslinker and second crosslinker making up the copolymer particulate, as disclosed herein, can be selected to tune the exact swelling rate of the copolymer particulate which can result in a range from about 20% down to about 0.01% swelling capacity by the time the cement sheath is set which is normally about eight to twelve hours. Moreover, the exact selection of the amount of swelling permitted during the cement sheath setting period will be dictated, at least in part, by the exact cement formulation employed and the conditions in the wellbore, such as temperature and water content, for example. In some embodiments, no appreciable swelling occurs on the time scale of eight to twelve hours for the cement sheath to set. During that period of time, the slowly degradable polymer provides, in part, some of the delayed swelling response.

In some embodiments, the swelling of the copolymer particulate in response to a void created in the set cement sheath can be selected in a manner consistent with the conditions selected for compatibility with the time for setting of the cement sheath. As described herein above, the copolymer particulate may exhibit a delayed swelling during the cement setting as a function of, at least in part, the amount of water degradable first crosslinker and the second crosslinker. In some embodiments, higher concentrations of the water degradable crosslinker improve the swelling resistance thus enhancing the delay period. In some embodiments, a polyfunctional, such as a trifunctional or tetrafunctional degradable crosslinker can be used to further delay the onset of swelling. Thus, in some embodiments, the swelling of the copolymer particulate in response to a void created in the set cement sheath can be selected to be substantially passive when exposed to water. In other embodiments, the swelling of the copolymer particulate in response to a void created in the set cement sheath can be selected to require altering the conditions in the wellbore due to the relatively slow swelling response of the copolymer particulate in the presence of water. As shown below in Example I, an exemplary copolymer particulate formulation exhibited altered swelling rates with changes in temperature, consistent with this embodiment.

In some embodiments, methods of the invention employ a copolymer particulate that includes particulates having a particulate size in a range from about 100 microns to about 2000 microns, including any sub-range of particulate sizes in between and fractions thereof. By “particulate size,” it is meant an effective diameter as known in the art and, as described herein above, is not intended to imply that the particulates are necessarily spherical in shape. In some embodiments, methods of the invention employ a copolymer particulate that includes particulates having a particulate size in a range from about 200 microns to about 1500 microns. In some embodiments, methods of the invention employ a copolymer particulate that includes particulates having a particulate size in a range from about 500 microns to about 1000 microns. In some embodiments, methods of the invention employ a copolymer particulate size of at least about 100, 200, 300, 400, 500, 600, 700, 800, 900, 1000, 1100, 1200, 1300, 1400, 1500, 1600, 1700, 1800, 1900, and about 2000 microns, including any value in between and fractions thereof. One skilled in the art will recognize that choice of size or distribution of sizes may be linked to the size and choice of cementitious particulate and the anticipated properties of the set cement sheath, including, for example, its porosity.

In some embodiments, methods of the invention employ copolymer particulates that include a monofunctional monomer comprising at least one monomer selected from the group consisting of N,N-dimethylacrylamide, 2-acrylamido-2-methylpropanesulfonic acid (AMPS) or salt thereof, an acrylic acid salt, a sulfonated styrene, a vinylsulfonic acid salt, N-(hydroxyethyl)acrylamide, acrylamide, N-methylacrylamide, methacrylamide, N-vinylformamide, 1-vinyl-2-pyrrolidinone, N-vinylcaprolactam, N-acryloyl morpholine, N-methyl-N-vinylacetamide, N-vinylacetamide, N-isopropylacrylamide, N,N-diethylacrylamide, 2-hydroxyethyl acrylate, 2-hydroxypropyl acrylate, diallyldimethylammonium chloride and combinations thereof. In some embodiments, the monofunctional monomer comprises a combination of N,N-dimethylacrylamide and 2-acrylamido-2-methylpropanesulfonic acid (AMPS) or salt thereof. In some embodiments, the monofunctional monomer comprises an acrylate salt, such as sodium or potassium acrylate.

In some embodiments, methods of the present invention employ a copolymer particulate having at least one monofunctional monomer present in a range from about 80 to about 99% by weight of the copolymer particulate. In some embodiments, a monofunctional monomer is present in about 80%, 81%, 82%, 83%, 84%, 85%, 86%, 87%, 88%, 89%, 90%, 91%, 92%, 93%, 94%, 95%, 96%, 97%, 98%, and 99% by weight of the copolymer particulate, including any fraction thereof.

In some embodiments, methods of the present invention employ a copolymer particulate having a water degradable first crosslinker that includes at least one selected from the group consisting of ethylene diacrylate, polyethylene glycol diacrylate with 2 to 30 ethylene glycol units, polyethylene glycol dimethacrylate with 2 to 30 ethylene glycol units, glycerol dimethacrylate, triglycerol diacrylate, ethoxylated glycerol diacrylate, ethoxylated glycerol triacrylate, pentaerythritol tetraacrylate, ethoxylated pentaerythritol tetraacrylate, pentaerythritol triacrylate, trimethylolpropane triacrylate, ethoxylated trimethylolpropane triacrylate, and combinations thereof

In some embodiments, methods of the present invention employ a copolymer particulate having a water degradable first crosslinker present in a range from about 0.1% to about 20% by weight of the copolymer. In some embodiments, the water degradable first crosslinker is present at about 0.1%, 0.2%, 0.3%, 0.4%, 0.5%, 1%, 2%, 3%, 4%, 5%, 6%, 7%, 8%, 9%, 10%, 11%, 12%, 13%, 14%, 15%, 16%, 17%, 18%, 19%, and 20% by weight of the copolymer, including all values in between and fractions thereof. In still further embodiments, the water degradable first crosslinker is present in a range from about 3% to about 7% by weight of the copolymer. In some embodiments, the water degradable first crosslinker is present at about 3%, 3.5%, 4%, 4.5%, 5%, 5.5%, 6%, 6.5%, and about 7% by weight of the copolymer, including all values in between and fractions thereof

In some embodiments, methods of the invention employ a copolymer particulate having a second crosslinker comprising at least one selected from the group consisting of N,N′-methylenebisacrylamide, N,N′-methylenebismethacrylamide, N,N′-(1,2-dihydroxy-1,2-ethanediyl)bisacrylamide, N,N′(1,2-ethanediyl)bisacrylamide, and N,N′-[[2,2-bis(hydroxymethyl)-1,3-propanediyl]bis(oxymethylene)]bisacrylamide, bis(2-methacryloyl)oxyethyl disulfide, divinyl sulfone and N,N′-bis(acryloyl)cystamine, and combinations thereof.

In some embodiments, methods of the present invention employ a copolymer particulate having a second crosslinker present in a range from about 0.0005% to about 0.5% by weight of the copolymer. In some embodiments, methods of the present invention employ a copolymer particulate having a second crosslinker present at about 0.0005%, 0.001%, 0.002%, 0.003%, 0.004%, 0.005%, 0.01%, 0.02%, 0.03%, 0.04%, 0.05%, 0.1%, 0.15%, 0.2%, 0.25%, 0.3%, 0.35%, 0.4%, 0.45%, and 0.5% by weight of the copolymer, including all values in between and fractions thereof.

In some embodiments, methods of the invention include a time period for the onset of swelling of the copolymer particulate in a range from about 2 hours to about 24 hours. In some embodiments, the onset of swelling is in a range from about 8 hours to about 12 hours. In such embodiments, the onset of swelling begins within the approximate time frame that the cement sheath sets. In some embodiments, the onset of swelling is in a range from between about 12 hours to about 24 hours. In such embodiments, the swelling of the copolymer particulate is sufficiently delayed that the cement sheath has time to set before any substantial swelling occurs. In some embodiments the time period for the onset of swelling of the copolymer particulate is about 2, 3, 4, 5, 6, 7, 8, 9, 10, 11, 12, 13, 14, 15, 16, 17, 18, 19, 20, 21, 22, 23, or about 24 hours, including any values in between and fractions thereof. Delayed onset of swelling can occur by various mechanisms. In one embodiment, delayed onset of swelling occurs as an inherent property of the size of the copolymer particulate.

In some embodiments, methods of the present invention utilize a copolymer particulate that swells only minimally under a first set of conditions, but will swell considerably under a second set of conditions. For example, a copolymer particulate utilized in methods of the present invention may only swell taking up 10% of its weight in water at a first temperature, but may take up 100% of its weight at a second higher temperature in the same amount of time. Similarly, a copolymer particulate may only swell taking up 10% of its weight in water at a first pH, but may take up 100% of its weight at a second pH in the same amount of time. One skilled in the art will recognize that the first and second set of conditions will have associated response times. In some embodiments, employing first and second conditions provides a means for inducing swelling of the copolymer particulate in response to altered conditions provided by an operator of the wellbore. In some embodiments, employing first and second conditions provides a means for passive swelling of the copolymer particulate in response to altered conditions within the cement sheath in response to exposure of a void created in the cement sheath to, for example, the absence of water (first condition) or presence of water (second condition).

In some embodiments, the present invention provides a cement composition comprising a cementitious particulate and a copolymer particulate capable of swelling in response to the presence of a fluid comprising water. Consistent with embodiments of the invention, the swelling of the copolymer particulate does not impair setting of the cement composition. Moreover, swelling and water uptake is still available after the cement compositions of the invention have set.

In some embodiments, the present invention provides a cement composition comprising a cementitious particulate and a copolymer particulate capable of swelling in response to the presence of a fluid comprising water, the copolymer particulate comprising a mixture of water labile and water stable crosslinkers. In some such embodiments, the ratio of water labile to water stable crosslinker is in a range from about 2000:1 to about 10:1. In some embodiments, the ratio of water labile to water stable crosslinker is in a range from about 1500:1 to about 100:1. In some embodiments, the ratio of water labile to water stable crosslinker is in a range from about 1000:1 to about 200:1. In some embodiments, the ratio of water labile to water stable crosslinker is in a range from about 2000:1 to about 1500:1. In some embodiments, the ratio of water labile to water stable crosslinker is in a range from about 1500:1 to about 1000:1. In some embodiments, the ratio of water labile to water stable crosslinker is in a range from about 1000:1 to about 500:1. In some embodiments, the ratio of water labile to water stable crosslinker is in a range from about 500:1 to about 100:1. In some embodiments, the ratio of water labile to water stable crosslinker is in a range from about 100:1 to about 10:1. In some embodiments, the larger the ratio of water labile to water stable crosslinker, the longer the delay for the onset of swelling.

In some embodiments, the present invention provides a cement composition comprising a cementitious particulate and a copolymer particulate capable of swelling in response to the presence of a fluid comprising water, the copolymer particulate having an effective diameter in a range from about 100 microns to about 2000 microns. In some such embodiments, size is selected to provide a delayed onset of swelling, with larger copolymer particulate sizes providing greater swelling delay.

In some embodiments, the present invention provides a cementing composition comprising an aqueous fluid, a cementitious particulate, and a copolymer particulate comprising a monofunctional monomer, a water degradable first crosslinker, and a second crosslinker. When in use, the copolymer particulate allows the cementing composition to set before substantial swelling of the copolymer particulate occurs.

Suitable aqueous fluids for use in the present invention may comprise fresh water, saltwater (e.g., water containing one or more salts dissolved therein), brine (e.g., saturated salt water), seawater, and any combination thereof. Generally, the water may be from any source, provided that it does not contain components that might adversely affect the stability and/or performance of the compositions or methods of the present invention.

In some embodiments, the cement compositions of the invention comprise a hydraulic cement. Suitable hydraulic cements for use in the present invention can include any known hydraulic cement including, but are not limited to, a Portland cement including API classes A, B, C, G, and H; a slag cement; a pozzolana cement; a gypsum cement; an aluminous cement; a silica cement; a high alkalinity cement; and any combination thereof.

In some embodiments, the cementing composition of the invention includes a copolymer particulate having an effective particulate size in a range from about 100 microns to about 2000 microns, including any sub-range of particulate sizes in between and fractions thereof. By “effective particulate size,” it is meant an effective diameter as known in the art and, as described herein above, is not intended to imply that the particulates are necessarily spherical in shape. In some embodiments, methods of the invention employ a copolymer particulate that includes particulates having a particulate size in a range from about 200 microns to about 1500 microns. In some embodiments, methods of the invention employ a copolymer particulate that includes particulates having a particulate size in a range from about 500 microns to about 1000 microns. In some embodiments, methods of the invention employ a copolymer particulate size of at least about 100, 200, 300, 400, 500, 600, 700, 800, 900, 1000, 1100, 1200, 1300, 1400, 1500, 1600, 1700, 1800, 1900, and about 2000 microns, including any value in between and fractions thereof. One skilled in the art will recognize that choice of size or distribution of sizes may be linked to the size and choice of cementitious particulate and the anticipated properties of the set cement sheath, including, for example, its porosity. Without being bound by theory, larger particle sizes can reduce the effective surface area and provide beneficial delayed onset of swelling. In some embodiments, the copolymer particulate is provided in a monodisperse distribution. In some embodiments, the copolymer particulate is provided in a polydisperse distribution. In some embodiments, the copolymer particulate is provided in a bidisperse distribution.

In some embodiments, the cementing composition of the invention employs copolymer particulates that include a monofunctional monomer comprising at least one monomer selected from the group consisting of N,N-dimethylacrylamide, 2-acrylamido-2-methylpropanesulfonic acid (AMPS™) or salt thereof, an acrylic acid salt, a sulfonated styrene, a vinylsulfonic acid salt, N-(hydroxyethyl)acrylamide, acrylamide, N-methylacrylamide, methacrylamide, N-vinylformamide, 1-vinyl-2-pyrrolidinone, N-vinylcaprolactam, N-acryloyl morpholine, N-methyl-N-vinylacetamide, N-vinylacetamide, N-isopropylacrylamide, N,N-diethylacrylamide, 2-hydroxyethyl acrylate, 2-hydroxypropyl acrylate, diallyldimethylammonium chloride and combinations thereof. In some embodiments, the monofunctional monomer comprises a combination of N,N-dimethylacrylamide and 2-acrylamido-2-methylpropanesulfonic acid (AMPS) or salt thereof. In some embodiments, the monofunctional monomer comprises an acrylate salt, such as sodium or potassium acrylate.

In some embodiments, the cementing composition of the present invention employ a copolymer particulate having at least one monofunctional monomer present in a range from about 80% to about 99% by weight of the copolymer particulate. In some embodiments, a monofunctional monomer is present in about 80%, 81%, 82%, 83%, 84%, 85%, 86%, 87%, 88%, 89%, 90%, 91%, 92%, 93%, 94%, 95%, 96%, 97%, 98%, and 99% by weight of the copolymer particulate, including any fraction thereof.

In some embodiments, methods of the present invention employ a copolymer particulate having a water degradable first crosslinker that includes at least one selected from the group consisting of ethylene diacrylate, polyethylene glycol diacrylate with 2 to 30 ethylene glycol units, polyethylene glycol dimethacrylate with 2 to 30 ethylene glycol units, glycerol dimethacrylate, triglycerol diacrylate, ethoxylated glycerol diacrylate, ethoxylated glycerol triacrylate, pentaerythritol tetraacrylate, ethoxylated pentaerythritol tetraacrylate, pentaerythritol triacrylate, trimethylolpropane triacrylate, ethoxylated trimethylolpropane triacrylate, and combinations thereof

In some embodiments, the cementing composition of the present invention employs a copolymer particulate having a water degradable first crosslinker present in a range from about 0.1% to about 20% by weight of the copolymer. In some embodiments, the water degradable first crosslinker is present at about 0.1%, 0.2%, 0.3%, 0.4%, 0.5%, 1%, 2%, 3%, 4%, 5%, 6%, 7%, 8%, 9%, 10%, 11%, 12%, 13%, 14%, 15%, 16%, 17%, 18%, 19%, and 20% by weight of the copolymer, including all values in between and fractions thereof. In still further embodiments, the water degradable first crosslinker is present in a range from about 3% to about 7% by weight of the copolymer. In some embodiments, the water degradable first crosslinker is present at about 3%, 3.5%, 4%, 4.5%, 5%, 5.5%, 6%, 6.5%, and about 7% by weight of the copolymer, including all values in between and fractions thereof.

In some embodiments, the cementing composition of the invention employs a copolymer particulate having a second crosslinker comprising at least one selected from the group consisting of N,N′-methylenebisacrylamide, N,N′-methylenebismethacrylamide, N,N′-(1,2-dihydroxy-1,2-ethanediyl)bisacrylamide, N,N(1,2-ethanediyl)bisacrylamide, and N,N′-[[2,2-bis(hydroxymethyl)-1,3 -propanediyl]bis(oxymethylene)]bisacrylamide, bis(2-methacryloyl)oxyethyl disulfide, divinyl sulfone and N,N′-bis(acryloyl)cystamine, and combinations thereof

In some embodiments, the cementing composition of the present invention employs a copolymer particulate having a second crosslinker present in a range from about 0.0005% to about 0.5% by weight of the copolymer. In some embodiments, methods of the present invention employ a copolymer particulate having a second crosslinker present at about 0.0005%, 0.001%, 0.002%, 0.003%, 0.004%, 0.005%, 0.01%, 0.02%, 0.03%, 0.04%, 0.05%, 0.1%, 0.15%, 0.2%, 0.25%, 0.3%, 0.35%, 0.4%, 0.45%, and 0.5% by weight of the copolymer, including all values in between and fractions thereof.

In some embodiments, the present invention provides a copolymer particulate comprising a monofunctional monomer selected from the group consisting of 1) a mixture of 2-acrylamido-2-methylpropane sulfonic acid (AMPS) or salt thereof and N,N-dimethylacrylamide and 2) an acrylate salt, a diacrylate ester first crosslinking agent, and a second crosslinking agent. In some such embodiments, the copolymer particulate comprises particulates that have a particulate size in a range from about 100 microns to about 2000 microns.

As described herein above, the diacrylate ester can function as the water degradable first crosslinker. Thus, the labile ester linkage provides a means of degrading the copolymer particulate structures to open the polymer network and increase the uptake of water. In the case of an ester linkage, in particular, the ester bond may be cleaved in water under acidic conditions, for example in the presence of a protic or Lewis acid. The ester bond may also be cleaved in water under basic conditions at or above a pH of about 9. The ester bond may also be cleaved in water at elevated temperatures. The skilled artisan will recognize that the ester linkage can be cleaved at any pH and that the rate of cleavage is variable across pH. In some embodiments, the ester linkage may exhibit the greatest stable at a pH of about 5.

Although the invention has been described with particularity in applications to mitigating damage in cement sheaths in wellbore casings, the skilled artisan will recognize the broader applicability of the compositions and methods described herein. For example, copolymer particulates of the invention may be included in an outer layer of gunnite prior to plastering a pool and provide leakage prevention when the plaster layer is damaged. Similarly, cement sheaths used in sewage treatment containment may also benefit from the principles described herein.

It should be noted that when “about” is provided at the beginning of a numerical list, “about” modifies each number of the numerical list. It should be noted that in some numerical listings of ranges, some lower limits listed may be greater than some upper limits listed. One skilled in the art will recognize that the selected subset will require the selection of an upper limit in excess of the selected lower limit.

To facilitate a better understanding of the present invention, the following examples of preferred embodiments are given. In no way should the following examples be read to limit, or to define, the scope of the invention.

### EXAMPLE I

This example shows the swelling uptake characteristics of an exemplary copolymer particulate in accordance with one embodiment of the invention.

Copolymer Preparation Procedure:

A 250 mL round bottom, 3 necked flask was fitted with an overhead stirrer and a nitrogen purge. The flask was charged with 100 ml Escaid 110 (ExxonMobil Chemical) and Hypermer 1031 (Croda) (volume as indicated below). The monomer solution was added and the stirring rate set with a tachometer. After the polymerization was complete, the product was mixed with 300 mL, of acetone in a 1 liter Erlenmeyer flask. The product was collected on a Büchner funnel, rinsed with acetone, and dried.

Copolymer particulate starting materials:

1.001 g Polyethylene glycol diacrylate, Mn=258

15.005 g N,N-dimethylacrylamide

10.002 g AMPS 2405 (Lubrizol)

15.019 g DI water

0.20 ml 0.5% w/v N,N′-methylenebisacrylamide

0.2 ml triethanolamine

0.2 ml 10% w/v sodium persulfate

0.1 ml Hypermer 1031 in 100 ml of Escaid 110, 200 rpm stirring rate

Product wt 24.130 g

Swelling Test Experiment

100 grams of fresh water was adjusted to pH of 11.15 with 25% sodium hydroxide solution to mimic the pH of a typical cement. Swelling tests were performed at 80° F. and 130° F. in a thermostatted water bath. 4-ounce glass bottles were charged with 4 grams of copolymer particulate and 100 g of pH 11.15 water. After shaking, the bottles were placed in water baths and the volume occupied by the particulate was monitored. pH was maintained at 11.15 in both samples and checked during the experiment. The particulate volumes as a percent of the total volume as a function of time and temperature are tabulated below in Table I.

TABLE I

| Time (hours) | Temp. (° F.) | Particulate volume, % |
|---|---|---|
| 0 | 80 | — |
| 2 | 80 | 10 |
| 4 | 80 | 10 |
| 7.5 | 80 | 10 |
| 10.5 | 80 | 10 |
| 23 | 80 | 10 |
| 0 | 130 | — |
| 2 | 130 | 10 |
| 4 | 130 | 10 |
| 7.5 | 130 | 35 |
| 10.5 | 130 | 50 |
| 23 | 130 | 100 |

As shown in Table I, at 80° F. the copolymer particulate did not swell appreciably over the 23 hour duration of the test. By contrast, at 130° F. the copolymer particulate shows increased water uptake commencing after four hours. This demonstrates the ability to alter conditions to change the rate of swelling of the copolymer particulate.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A method comprising:
providing a cementing composition comprising an aqueous fluid; a cementitious particulate; and a copolymer particulate comprising:
a monofunctional monomer;
a water degradable first crosslinker; and
a second crosslinker;
placing the cementing composition in a subterranean formation so as to form a set cement sheath; and
swelling said copolymer particulate in response to a void created in said set cement sheath;
wherein said copolymer particulate allows the cementing composition to set to form the cement sheath before substantial swelling of the copolymer particulate occurs.

2. The method of claim 1, wherein said copolymer particulate comprises particulates that have a particulate size in a range from about 100 microns to about 2000 microns.

3. The method of claim 1, wherein said monofunctional monomer comprises at least one selected from the group consisting of N,N-dimethylacrylamide, 2-acrylamido-2-methylpropanesulfonic acid (AMPS) or salt thereof, an acrylic acid salt, a sulfonated styrene, a vinylsulfonic acid salt, N-(hydroxyethyl)acrylamide, acrylamide, N-methylacrylamide, methacrylamide, N-vinylformamide, 1-vinyl-2-pyrrolidinone, N-vinylcaprolactam, N-acryloyl morpholine, N-methyl-N-vinylacetamide, N-vinylacetamide, N-isopropylacrylamide, N,N-diethylacrylamide, 2-hydroxyethyl acrylate, 2-hydroxypropyl acrylate, diallyldimethylammonium chloride and combinations thereof.

4. The method of claim 1, wherein said monofunctional monomer is present in a range from about 80% to about 99% by weight of the copolymer particulate.

5. The method of claim 1, wherein said water degradable first crosslinker comprises at least one selected from the group consisting of ethylene diacrylate, polyethylene glycol diacrylate with 2 to 30 ethylene glycol units, polyethylene glycol dimethacrylate with 2 to 30 ethylene glycol units, glycerol dimethacrylate, triglycerol diacrylate, ethoxylated glycerol diacrylate, ethoxylated glycerol triacrylate, pentaerythritol tetraacrylate, ethoxylated pentaerythritol tetraacrylate, pentaerythritol triacrylate, trimethylolpropane triacrylate, ethoxylated trimethylolpropane triacrylate, and combinations thereof.

6. The method of claim 1, wherein said water degradable first crosslinker is present in a range from about 0.1% to about 20% by weight of the copolymer.

7. The method of claim 6, wherein said water degradable first crosslinker is present in a range from about 3% to about 7% by weight of the copolymer.

8. The method of claim 1, wherein said second crosslinker comprises at least one selected from the group consisting of N,N′-methylenebisacrylamide, N,N′-methylenebismethacrylamide, N,N′-(1,2-dihydroxy-1,2-ethanediyl)bisacrylamide, N,N′-(1,2-ethanediyl)bisacrylamide, and N,N′-[[2,2-bis(hydroxymethyl)-1,3-propanediyl]bis(oxymethylene)]bisacrylamide, bis(2-methacryloyl)oxyethyl disulfide, divinyl sulfone and N,N′-bis(acryloyl)cystamine, and combinations thereof

9. The method of claim 1, wherein said second crosslinker is present in a range from about 0.0005% to about 0.5% by weight of the copolymer.

10. The method of claim 1, wherein a time period for the onset of swelling is in a range from about 2 hours to about 24 hours.

11. A cementing composition comprising:
an aqueous fluid;
a cementitious particulate; and
a copolymer particulate comprising:
a monofunctional monomer;
a water degradable first crosslinker; and
a second crosslinker;
wherein when in use, said copolymer particulate allows the cementing composition to set before substantial swelling of the copolymer particulate occurs.

12. The cementing composition of claim 11, wherein said copolymer particulate has a particulate size in a range from about 100 microns to about 2000 microns.

13. The cementing composition of claim 11, wherein said monofunctional monomer comprises at least one selected from the group consisting of N,N-dimethylacrylamide, 2-acrylamido-2-methylpropanesulfonic acid (AMPS) or salt thereof, an acrylic acid salt, a sulfonated styrene, a vinylsulfonic acid salt, N-(hydroxyethyl)acrylamide, acrylamide, N-methylacrylamide, methacrylamide, N-vinylformamide, 1-vinyl-2-pyrrolidinone, N-vinylcaprolactam, N-acryloyl morpholine, N-methyl-N-vinylacetamide, N-vinylacetamide, N-isopropylacrylamide, N,N-diethylacrylamide, 2-hydroxyethyl acrylate, 2-hydroxypropyl acrylate and combinations thereof.

14. The cementing composition of claim 11, wherein said monofunctional monomer is present in a range from about 80% to about 99% by weight of the copolymer particulate.

15. The cementing composition of claim 11, wherein said water degradable first crosslinker comprises at least one selected from the group consisting of ethylene diacrylate, polyethylene glycol diacrylate with 2 to 30 ethylene glycol units, polyethylene glycol dimethacrylate with 2 to 30 ethylene glycol units, glycerol dimethacrylate, triglycerol diacrylate, ethoxylated glycerol diacrylate, ethoxylated glycerol triacrylate, pentaerythritol tetraacrylate, ethoxylated pentaerythritol tetraacrylate, pentaerythritol triacrylate, trimethylolpropane triacrylate, ethoxylated trimethylolpropane triacrylate, and combinations thereof

16. The cementing composition of claim 11, wherein said water degradable first crosslinker is present in a range from about 0.1% to about 20% by weight of the copolymer.

17. The cementing composition of claim 11, wherein said water degradable first crosslinker is present in a range from about 3% to about 7% by weight of the copolymer.

18. The cementing composition of claim 11, wherein said second crosslinker comprises at least one selected from the group consisting of N,N′-methylenebisacrylamide, N,N′-methylenebismethacrylamide, N,N′-(1,2-dihydroxy-1,2-ethanediyl)bisacrylamide, N,N′-(1,2-ethanediyl)bisacrylamide, and N,N′-[[2,2-bis(hydroxymethyl)-1,3 -propanediyl]bis(oxymethylene)]bisacrylamide, bis(2-methacryloyl)oxyethyl disulfide, divinyl sulfone and N,N′-bis(acryloyl)cystamine, and combinations thereof

19. The cementing composition of claim 11, wherein said second crosslinker is present in a range from about 0.0005% to about 0.5% by weight of the copolymer.

20. A copolymer particulate comprising:
a monofunctional monomer selected from the group consisting of 1) a mixture of 2-acrylamido-2-methylpropane sulfonic acid (AMPS) or salt thereof and N,N-dimethylacrylamide and 2) an acrylate salt;
a diacrylate ester first crosslinking agent; and
a second crosslinking agent;
wherein said copolymer particulate comprises particulates that have a particulate size in a range from about 100 microns to about 2000 microns.
